(19) United States
(12) Patent Application Publication
(10) Pub. No.: US 2022/0301004 A1
(43) Pub. Date: Sep. 22, 2022

(54) CLICK RATE PREDICTION MODEL CONSTRUCTION DEVICE

(71) Applicant: NTT DOCOMO, INC., Chiyoda-ku (JP)

(72) Inventors: Tsukasa DEMIZU, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/638,094

(22) PCT Filed: Aug. 25, 2020
(86) PCT No.: PCT/JP2020/032050

§ 371 Date: Feb. 24, 2022

(30) Foreign Application Priority Data
Aug. 30, 2019 (JP) 2019-158314

(51) Int. Cl. G06Q 30/02

(52) U.S. Cl. CPC G06Q 30/0247; G06Q 30/0201

(57) ABSTRACT

An click rate prediction model construction device 1 includes: an image generating unit 13 configured to generate a plurality of similar images S similar to a basic image B which is displayed as an advertisement; a derivation unit 14 configured to derive an estimated value of a click rate of each of the plurality of similar images S on the basis of an actual value and a certainty factor of a click rate of the basic image B; and a model constructing unit 15 configured to learn the actual value and the estimated value of the click rate of the basic image B for each of the plurality of similar images S and to construct a click rate prediction model.

### TECHNICAL FIELD

An aspect of the present invention relates to a click rate prediction model construction device.

### BACKGROUND ART

Patent Literature 1 discloses a technique of acquiring log data associated with clicks on an advertisement in a web page in which a plurality of advertisements are displayed and calculating a click rate of the advertisement.

### CITATION LIST

### Patent Literature

[Patent Literature 1] Japanese Patent Application Laid-Open No. 2019-28591

### SUMMARY OF INVENTION

### Technical Problem

Purchasing of an online advertisement is performed, for example, on the basis of a score based on a click rate and a bidding price of an advertisement. Accordingly, it is important to ascertain an accurate click rate. Here, it is difficult to acquire highly reliable information on a click rate of, for example, an advertisement which has never been displayed or an advertisement of which the number of displays is small. The click rate of such an advertisement needs to be predicted in some way.

An aspect of the present invention was invented in consideration of the aforementioned circumstances, and an objective thereof is to provide a click rate prediction model that can predict a click rate with high accuracy.

### Solution to Problem

A click rate prediction model construction device according to an aspect of the present invention includes: an image generating unit configured to generate a plurality of images similar to a basic image which is displayed as an advertisement; a derivation unit configured to derive an estimated value of a click rate of each of the plurality of images on the basis of an actual value and a certainty factor of a click rate of the basic image; and a model constructing unit configured to learn the actual value and the estimated value of the click rate of the basic image for each of the plurality of images and to construct a click rate prediction model. The derivation unit derives a value obtained by adding a noise corresponding to the certainty factor of the click rate of the basic image to the actual value of the click rate of the basic image as the estimated value of the click rate of each of the plurality of images.

In the click rate prediction model construction device according to the aspect of the present invention, a plurality of images similar to a basic image are generated, and estimated values of the click rates of the plurality of images are derived. When a click rate prediction model is constructed, it is considered that images similar to an image (a basic image) of which an actual value of a click rate has been acquired are generated and learning data is increased (inflated). In this case, it is considered that learning is performed on the basis of the premise that the click rates of the similar images are the same as that of the basic image. However, in the method of performing learning on the basis of the premise that the click rates of the similar images of which the actual values have not actually been acquired are simply considered to be the same as that of the basic image, it is not possible to construct a click rate prediction model with high accuracy. In this regard, in the click rate prediction model construction device according to the aspect of the present invention, an estimated value of a click rate of each of the plurality of similar images is derived. Specifically, a value obtained by adding a noise corresponding to a certainty factor of the click rate of the basic image to the actual value of the click rate of the basic image is derived as an estimated value of the click rate of each of the plurality of images. In this way, by using the value obtained by adding a noise corresponding to the certainty factor of the click rate of the basic image as the estimated value of the click rate of each of the plurality of images instead of using the actual value of the click rate of the basic image without any change, it is possible to improve generalization performance of the constructed click rate prediction model.

Accordingly, it is possible to provide a click rate prediction model that can predict a click rate with high accuracy.

### Advantageous Effects of Invention

According to the aspect of the present invention, it is possible to provide a click rate prediction model that can predict a click rate with high accuracy.

### BRIEF DESCRIPTION OF DRAWINGS

FIG. 1 is a diagram schematically illustrating a click rate prediction model construction device according to an embodiment of the present invention.

FIG. 2 is a diagram illustrating a process of generating a plurality of similar images from a basic image.

FIG. 3 is a diagram illustrating a process of adding a noise according to a certainty factor.

FIG. 4 is a diagram illustrating a functional configuration of the click rate prediction model construction device.

FIG. 5 is a diagram illustrating inflation of image data and addition of a noise to a click rate.

FIG. 6 is a diagram illustrating preparation of a learning data set.

FIG. 7 is a flowchart illustrating a process that is performed by the click rate prediction model construction device.

FIG. 8 is a diagram illustrating a hardware configuration of the click rate prediction model construction device.

FIG. 9 is a diagram illustrating a click rate prediction model construction device according to a modified example.

### DESCRIPTION OF EMBODIMENTS

Hereinafter, an embodiment of the present invention will be described in detail with reference to the accompanying drawings. In description with reference to the drawings, the same or similar elements will be referred to by the same reference signs and repeated description thereof will be omitted.

A click rate prediction model construction device according to this embodiment is a device that constructs a prediction model for predicting a click-through rate (CTR) of an online advertisement using the Internet (hereinafter simply referred to as an “advertisement”). The click rate represents a ratio of the number of clicks to the number of displayed advertisements (the number of impressions). The click rate is used, for example, as an index for performing purchase of an advertisement.

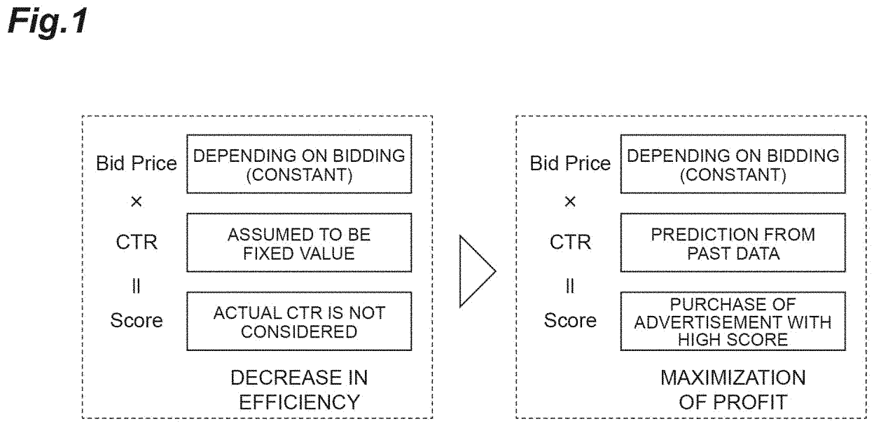

FIG. 1 is a diagram schematically illustrating the click rate prediction model construction device according to this embodiment and illustrates an advertisement purchase mode (specifically, an advertisement purchase mode for a new advertisement of which a click rate has never been counted) according to the related art and this embodiment. In FIG. 1, the left part illustrates an advertisement purchase mode according to the related art, and the right part illustrates an advertisement purchase mode according to this embodiment.

Purchase of advertisements is preferentially performed from an advertisement with a highest score which is derived on the basis of a bidding price and a click rate of the advertisement. As illustrated in the left part of FIG. 1, when purchasing of a new advertisement of which a click rate has never been counted (hereinafter also referred to as an unknown advertisement) is performed, the aforementioned score is derived on the basis of a bidding price (a constant) and a click rate assumed to be a fixed value in the related art. When purchasing of an advertisement is performed by deriving a score using a fixed value set as a click rate of an unknown advertisement in this way, there is concern of the score being different from a score based on an actual click rate. In this case, there is a problem in that efficiency of advertisement purchase decreases.

In this regard, as illustrated in the right part of FIG. 1, the click rate prediction model construction device according to this embodiment constructs a click rate prediction model for predicting a click rate of an unknown advertisement and predicts the click rate of the unknown advertisement using the constructed click rate prediction model. In predicting a click rate of an unknown advertisement using the click rate prediction model, past data (actual values of click rates) of advertisements similar to the unknown advertisement is considered. By deriving a score on the basis of a bidding price (a constant) and the predicted click rate and purchasing an advertisement with a high score, it is possible to improve efficiency of advertisement purchase and to realize maximization of profits from the advertisement in comparison with the related art. A functional configuration of the click rate prediction model construction device will be described below in detail.

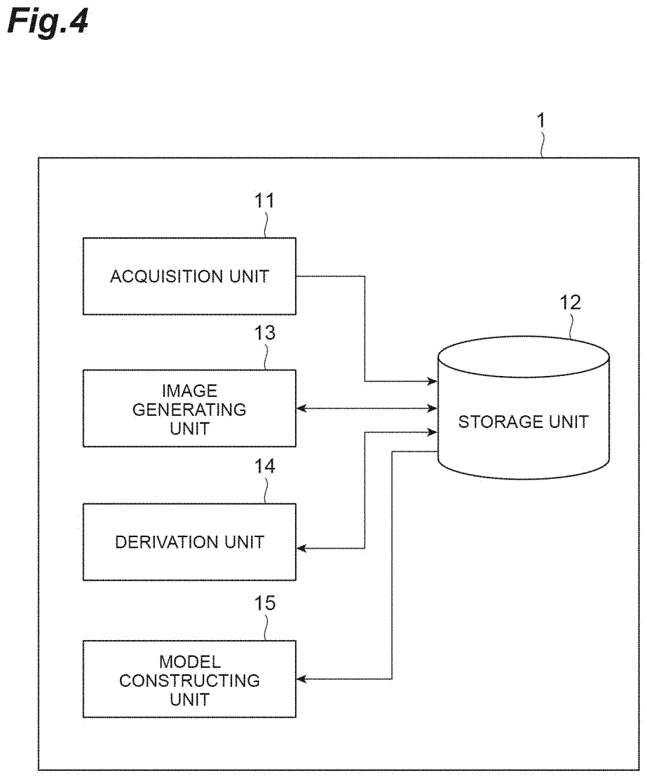

FIG. 4 is a diagram illustrating a functional configuration of the click rate prediction model construction device 1 according to this embodiment. The click rate prediction model construction device 1 may be a device that predicts a click rate using a constructed click rate prediction model or may be a device that transmits a constructed click rate prediction model to an external device. In this embodiment, only functions of the click rate prediction model construction device 1 associated with construction of a click rate prediction model will be described. As illustrated in FIG. 4, the click rate prediction model construction device 1 includes an acquisition unit 11, a storage unit 12, an image generating unit 13, a derivation unit 14, and a model constructing unit 15 as functional elements thereof.

The acquisition unit 11 acquires information associated with construction of a click rate prediction model. The acquisition unit 11 acquires, for example, an image of one or more advertisements (hereinafter also referred to as a basic image B) which has been distributed and of which an actual value of a click rate has been acquired and the number of clicks and the click rate of the basic image B. The acquisition unit 11 may acquire the aforementioned information using any means, for example, may acquire the information from an external device (not illustrated) or may acquire the information on the basis of an input from an operator of an advertisement distribution company or the like. The acquisition unit 11 stores the acquired basic image B and the number of clicks and the click rate of the basic image in the storage unit 12. The storage unit 12 is a database that stores various types of information acquired by the acquisition unit 11. The storage unit 12 also stores information generated (derived) by the image generating unit 13 and the derivation unit 14 which will be described later.

The image generating unit 13 generates a plurality of images (similar images S) similar to a basic image B (an image of an advertisement which has been distributed and of which an actual value of a click rate has been acquired) displayed as an advertisement. By causing the image generating unit 13 to generate a plurality of similar images S, learning data for constructing a click rate prediction model can be increased (inflated). The image generating unit 13 acquires a basic image B from the storage unit 12, generates a plurality of similar images S, and stores the generated similar images S in the storage unit 12.

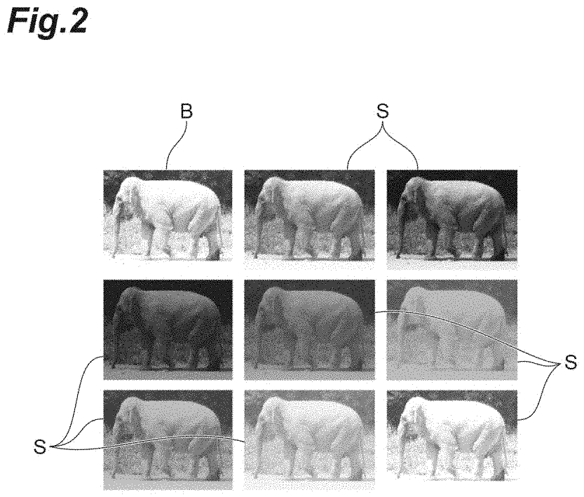

FIG. 2 is a diagram illustrating a process of generating a plurality of similar images S from a basic image B. In the example illustrated in FIG. 2, the image generating unit 13 generates eight similar images S by changing a color of a basic image B on the basis of the basic image B of which an actual value of a click rate has been acquired in advance. In this way, the image generating unit 13 generates, for example, a plurality of similar images S by changing a color of a basic image B. A pattern in which the image generating unit 13 generates similar images S is not limited thereto and, for example, the image generating unit 13 may generate images obtained by inverting the basic image B, images obtained by rotating the basic image B, or images obtained by adding a noise to the basic image B as the similar images S.

The derivation unit 14 derives an estimated value of a click rate of each of the plurality of similar images S on the basis of an actual value and a certainty factor of the click rate of the basic image B. The derivation unit 14 acquires the number of clicks and the click rate (an actual value) of the basic image B from the storage unit 12. The derivation unit 14 derives the certainty factor of the click rate, for example, on the basis of the number of clicks on the basic image B.

That is, the derivation unit 14 may increase the certainty factor indicating reliability of the click rate as the number of clicks increases. The derivation unit 14 may set the certainty factor of the actual value of the click rate to a relatively low value, for example, when the number of clicks is as small as several to several tens and set the certainty factor of the actual value of the click rate to a relatively high value, for example, when the number of clicks is as large as several hundred.

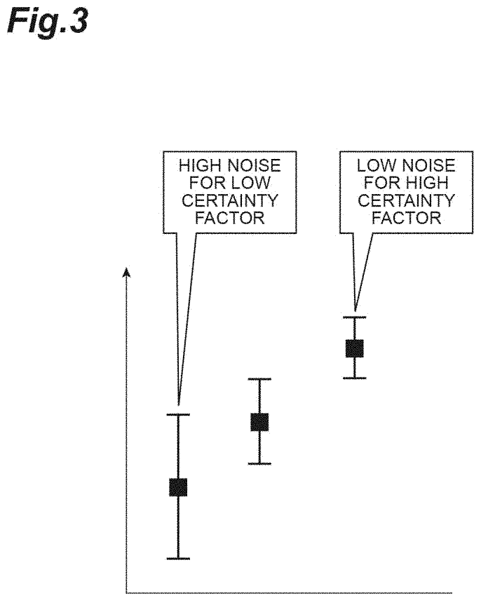

The derivation unit 14 derives a value obtained by adding a noise corresponding to the derived certainty factor to the actual value of the click rate of the basic image B as an estimated value of a click rate of each of the plurality of similar images S. FIG. 3 is a diagram illustrating a process of adding a noise according to a certainty factor. As illustrated in FIG. 3, the derivation unit 14 may derive the estimated value of the click rate of each similar image S by increasing the noise as the certainty factor of the click rate of the basic image B decreases and decreasing the noise as the certainty factor of the click rate of the basic image B increases. The derivation unit 14 may, for example, broaden a range of a value of the noise which is randomly added as the certainty factor of the click rate of the basic image B decreases and, for example, narrow the range of a value of the noise which is randomly added as the certainty factor of the click rate of the basic image B increases.

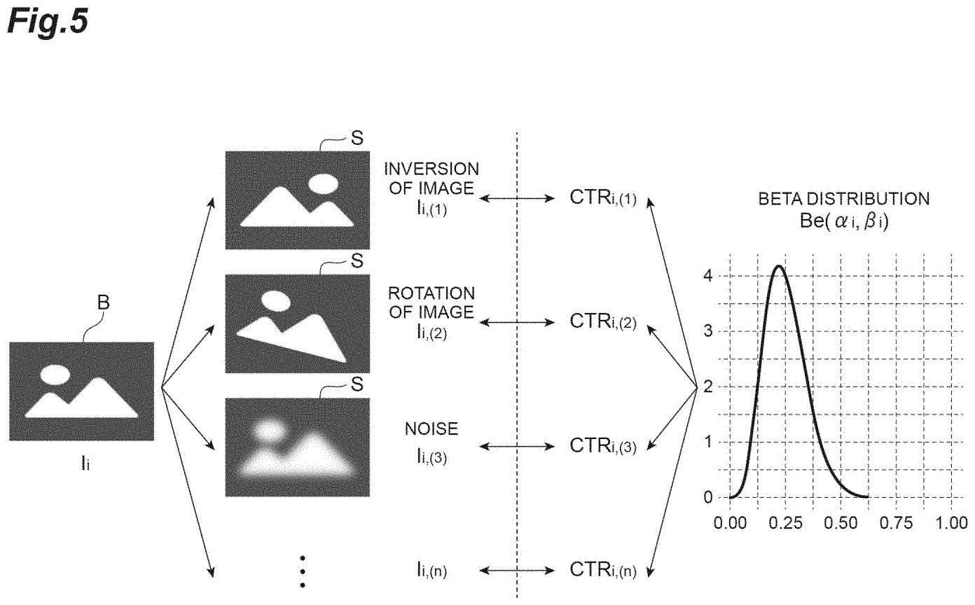

Addition of a noise corresponding to a certainty factor will be more specifically described below with reference to FIG. 5. FIG. 5 is a diagram illustrating inflation of image data and addition of a noise to a click rate. In the example illustrated in FIG. 5, n similar images S indicated by image feature values I_{i,(1)} to I_{i,(n)} are generated from a basic image B indicated by an image feature value Iᵢ, and image data is inflated. An image feature value is, for example, information indicating a feature of an image including 224×224 pixel information. As illustrated in FIG. 5, the similar image S indicated by the feature value I_{i,(1)} is an image obtained by inverting the basic image B, the similar image S indicated by the feature value I_{i,(2)} is an image obtained by rotating the basic image B, and the similar image S indicated by the feature value I_{i,(3)} is an image obtained by adding a noise to the basic image B. As illustrated in the right part of FIG. 5, the derivation unit 14 derives estimated values CTR_{i,(1)} to CTR_{i,(n)} of the click rates of the similar images S by adding noises to the similar images S on the basis of a beta distribution with the actual value of the click rate of the basic image B as a parameter. That is, the derivation unit 14 derives the estimated values CTR_{i,(1)} to CTR_{i,(n)} of the click rates (artificial click rates) of the similar images S to which noises have been added by sampling from a beta distribution with the number of clicks αᵢ and the number of non-clicks βᵢ of the basic image B as parameters. By deriving the estimated values of the click rates of the similar images S through sampling from the beta distribution, a value range of a noise which can be added is enlarged and a range of the estimated values of the click rates of the similar images S is enlarged when the number of impressions is small (the number of clicks is small) and the certainty factor of the click rate is low. On the other hand, the value range of a noise which can be added is narrowed and the range of the estimated values of the click rates of the similar images S is narrowed when the number of impressions is large (the number of clicks is large) and the certainty factor of the click rate is high.

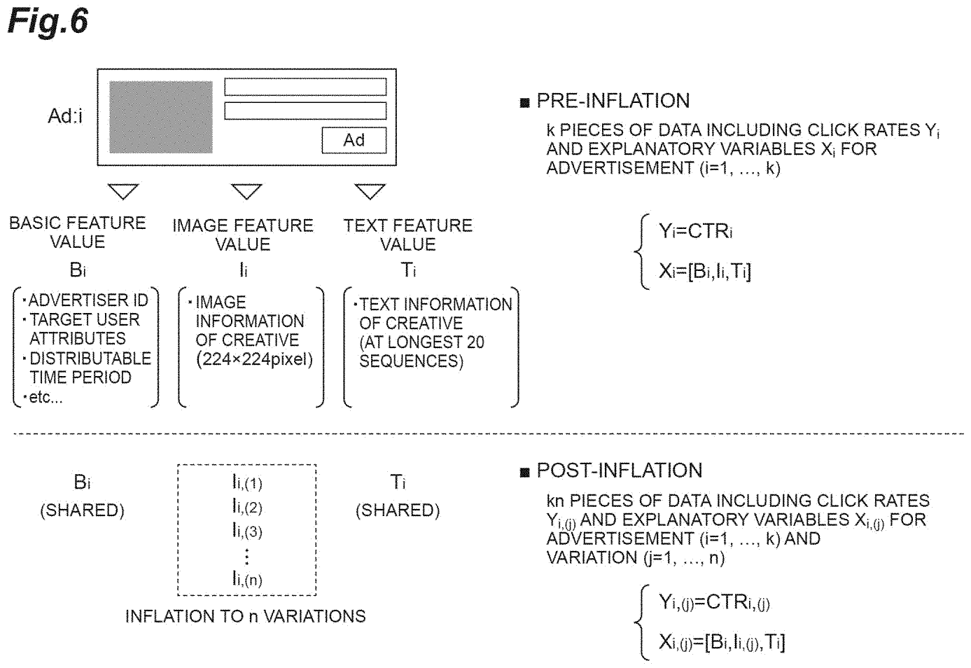

The derivation unit 14 prepares a learning data set based on a basic image B and a plurality of similar images S for each of a plurality of advertisements. FIG. 6 is a diagram illustrating preparation of a learning data set. The upper part of FIG. 6 is a diagram illustrating a case in which a learning data set is prepared from a basic image B (pre-inflation image) for each of a plurality of advertisements, and the lower part of FIG. 6 is a diagram illustrating a case in which a learning data set is prepared from the basic image B and a plurality of similar images S (post-inflation images) for each of the plurality of advertisements. As illustrated in the upper part of FIG. 6, the learning data set of each advertisement is represented by a basic feature value Bᵢ, an image feature value Iᵢ, and a text feature value Tᵢ of the advertisement. The basic feature value Bᵢ is information indicating basic information of an advertisement and is information such as an advertiser ID, target user attributes of the advertisement, and an advertisement distributable time period. The image feature value Iᵢ is information indicating features of an image in the advertisement (image information of a creative) and is, for example, 224×224 pixel information. The text feature value Tᵢ is information indicating features of text in the advertisement (text information of a creative).

As illustrated in the upper part (specifically, the right side of the upper part) of FIG. 6, for example, when learning data sets are prepared from each advertisement (i=1, . . . , k) without performing inflation of an image, a click rate Yᵢ and an explanatory variable Xᵢ for each advertisement (i=1, . . . , k) are prepared as the learning data sets. That is, k click rates Yᵢ and k explanatory variables Xᵢ are prepared. In this case, the click rate Yᵢ is expressed by Expression (1), and the explanatory variable Xᵢ is expressed by Expression (2). Here, CTRᵢ represents an actual value of the click rate for each advertisement.

Yᵢ=CTRᵢ (1)

Xᵢ=[Bᵢ,Iᵢ,Tᵢ] (2)

In this embodiment, the learning data sets are prepared by performing inflation of an image. In this case, as illustrated in the lower part of FIG. 6, n variation images are present on the basis of a basic image B and similar images S for each of a plurality of advertisements. That is, variations for image feature values I_{i,(1)} to I_{i,(n)} are present for each advertisement. The same advertisement has the same basic feature value Bᵢ and the same text feature value Tᵢ of the advertisement. Accordingly, n learning data sets with the same basic feature value Bᵢ and the same text feature value Tᵢ and with different image feature values Iᵢ are present for each advertisement in the post-inflation learning data sets.

As illustrated in the lower part (specifically, the right side of the lower part) of FIG. 6, when learning data sets are prepared from each advertisement (i=1, . . . , k) by performing inflation of an image, click rates Y_{i,(j)} and explanatory variables X_{i,(j)} for n variation images (j=1, . . . , n) of each advertisement are prepared as the learning data sets. That is, kn click rates Y_{i,(j)} and kn explanatory variables X_{i,(j)} are prepared. In this case, the click rate Y_{i,(j)} is expressed by Expression (3), and the explanatory variable X_{i,(j)} is expressed by Expression (4). Here, CTR_{i,(j)} represents an actual value of the click rate for the advertisement of the basic image B and represents an estimated value for the advertisement of the similar images S. The derivation unit 14 stores the learning data sets in the storage unit 12. As described above, each learning data set includes an actual value of a click rate of a basic image B and estimated values of click rates of a plurality of similar images S for each advertisement.

Y_{i,(j)}=CTR_{i,(j)} (3)

X_{i,(j)}=[Bᵢ,I_{i,(j)},Tᵢ] (4)

The model constructing unit 15 learns the learning data sets including an actual value of a click rate of a basic image B and estimated values of click rates of a plurality of similar images S for each advertisement and constructs a click rate prediction model. As described above, each learning data set includes explanatory variables for the advertisements in addition to the actual values and the estimated values of the click rates for the advertisements. The model constructing unit 15 constructs a click rate prediction model by learning the learning data sets, for example, using deep learning technology. For example, it is possible to appropriately estimate a click rate of an unknown advertisement and improve efficiency of advertisement purchase as described above using the click rate prediction model constructed by the model constructing unit 15.

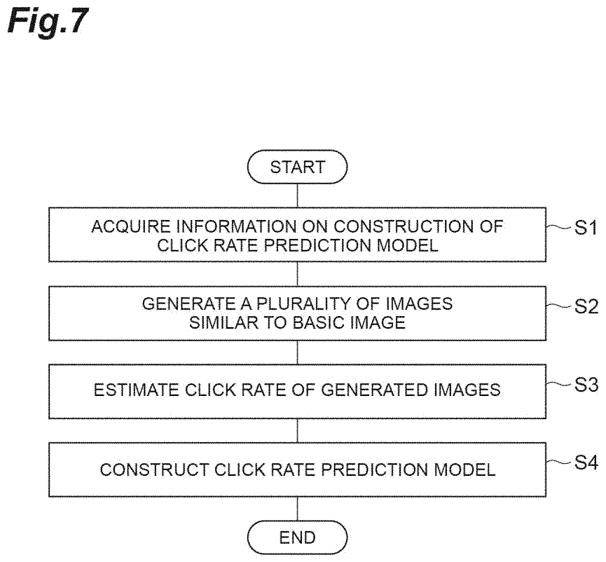

A process that is performed by the click rate prediction model construction device 1 will be described below with reference to FIG. 7. FIG. 7 is a flowchart illustrating a process that is performed by the click rate prediction model construction device 1.

As illustrated in FIG. 7, first, the click rate prediction model construction device 1 acquires information associated with construction of a click rate prediction model (Step S1). Specifically, the click rate prediction model construction device 1 acquires, for example, an image (hereinafter also referred to as a basic image B) of one or more advertisements which has been distributed and of which an actual value of a click rate has been acquired and the number of clicks and the click rate of the basic image B.

Subsequently, the click rate prediction model construction device 1 generates a plurality of images (similar images S) similar to the basic image B (the image which has been distributed and of which an actual value of a click rate has been acquired) and performs inflation of an image (Step S2).

Subsequently, the click rate prediction model construction device 1 derives an estimated value of a click rate of each of the plurality of similar images S on the basis of the actual value and the certainty factor of the click rate of the basic image B (Step S3). The click rate prediction model construction device 1 derives the certainty facto of the click rate, for example, on the basis of the number of clicks of the base image B. The click rate prediction model construction device 1 derives a value obtained by adding a noise corresponding to the derived certainty factor to the actual value of the click rate of the basic image B as an estimated value of the click rate of each of the plurality of similar images S. The click rate prediction model construction device 1 prepares a learning data set including the actual value of the click rate of the basic image B and the estimated values of the click rates of the plurality of similar images S for each advertisement.

Subsequently, the click rate prediction model construction device 1 learns the learning data set including the actual value of the click rate of the basic image B and the estimated values of the click rates of the plurality of similar images S for each advertisement and constructs a click rate prediction model (Step S4). The model constructing unit 15 constructs the click rate prediction model by learning the learning data sets, for example, using deep learning technology.

Operations and advantages of the click rate prediction model construction device 1 according to this embodiment will be described below.

The click rate prediction model construction device 1 according to this embodiment includes: the image generating unit 13 configured to generate a plurality of similar images S similar to a basic image B which is displayed as an advertisement; the derivation unit 14 configured to derive an estimated value of a click rate of each of the plurality of similar images S on the basis of an actual value and a certainty factor of a click rate of the basic image B; and the model constructing unit 15 configured to learn the actual value and the estimated value of the click rate of the basic image B for each of the plurality of similar images S and to construct a click rate prediction model. The derivation unit 14 derives a value obtained by adding a noise corresponding to the certainty factor of the click rate of the basic image B to the actual value of the click rate of the basic image B as the estimated value of the click rate of each of the plurality of similar images B.

In the click rate prediction model construction device 1 according to this embodiment, a plurality of similar images S similar to a basic image B are generated, and estimated values of the click rates of the plurality of similar images S are derived. When a click rate prediction model is constructed, it is considered that images similar to an image (a basic image) of which an actual value of a click rate has been acquired are generated and learning data is increased (inflated). In this case, it is considered that learning is performed on the basis of the premise that the click rates of the similar images are the same as that of the basic image. However, in the method of performing learning on the basis of the premise that the click rates of the similar images of which the actual values have not actually been acquired are simply considered to be the same as that of the basic image, it is not possible to construct a click rate prediction model with high accuracy. In this regard, in the click rate prediction model construction device 1 according to this embodiment, an estimated value of a click rate of each of the plurality of similar images S is derived. Specifically, a value obtained by adding a noise corresponding to a certainty factor of the click rate of the basic image B to the actual value of the click rate of the basic image B is derived as an estimated value of the click rate of each of the plurality of similar images S. In this way, by using the value obtained by adding a noise corresponding to the certainty factor of the click rate of the basic image B as the estimated value of the click rate of each of the plurality of similar images S instead of using the actual value of the click rate of the basic image B without any change, it is possible to improve generalization performance of the constructed click rate prediction model. That is, when learning data is inflated using unknown information through learning with addition of a noise, it is possible to achieve robustness of the constructed click rate prediction model. Accordingly, it is possible to provide a click rate prediction model that can predict a click rate with high accuracy. Since inflation of learning data can be efficiently performed, a technical advantage of decreasing a process load in a processor such as a CPU in learning can also be achieved.

The derivation unit 14 may increase the noise as the certainty factor of the click rate of the basic image B decreases and decrease the noise as the certainty factor of the click rate of the basic image B increases. Accordingly, the estimated value of the click rate can be made to be close to the actual value of the click rate of the basic image B by increasing the noise added to the similar images S, for example, when the number of clicks of the basic image B is not sufficiently large and reliability (certainty factor) of the click rate is low and decreasing the noise added to the similar images S, for example, when the number of clicks of the basic image B is sufficiently large and the reliability (certainty factor) of the click rate is high. As a result, it is possible to appropriately improve generalization performance of the constructed click rate prediction model by adding a sufficient noise to the estimated value when the certainty factor is low and to improve prediction accuracy of the click rate prediction model by not adding an unnecessary noise to the estimated value when the certainty factor is high.

The derivation unit 14 may add a noise according to the beta distribution with the actual value of the click rate of the basic image B as a parameter using a Bayesian estimation approach. In a case in which data on whether users are to click is taken from a Bernoulli distribution, a posterior distribution can be expressed by a beta distribution when the beta distribution is selected as a prior distribution. In this way, it is possible to appropriately derive estimated values of click rates of similar images S on the basis of an actual value of a click rate of a basic image B.

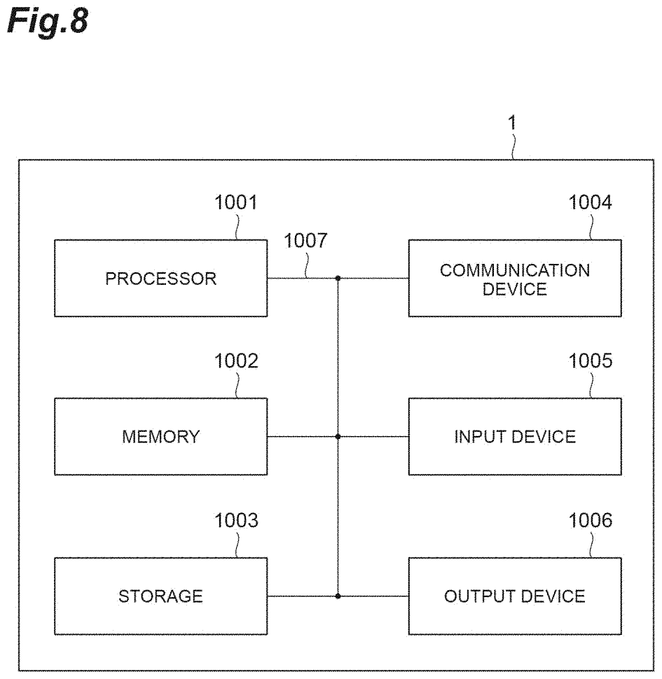

A hardware configuration of the click rate prediction model construction device 1 will be described below with reference to FIG. 8. The click rate prediction model construction device 1 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware configuration of the click rate prediction model construction device 1 may be configured to include one or more devices illustrated in the drawing or may be configured to exclude some devices thereof.

The functions of the click rate prediction model construction device 1 can be realized by reading predetermined software (program) to hardware such as the processor 1001 and the memory 1002 and causing the processor 1001 to execute arithmetic operations and to control communication using the communication device 1004 or to control at least one of reading and writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the control function of the derivation unit 14 or the like of the click rate prediction model construction device 1 may be realized by the processor 1001.

The processor 1001 reads a program (a program code), a software module, data, or the like from at least one of the storage 1003 and the communication device 1004 to the memory 1002 and performs various processes in accordance therewith. As the program, a program that causes a computer to perform at least some of the operations described in the above-mentioned embodiment is used. For example, the control function of the derivation unit 14 or the like of the click rate prediction model construction device 1 may be realized by a control program which is stored in the memory 1002 and which operates in the processor 1001, and the other functional blocks may be realized in the same way. The various processes described above are described as being performed by a single processor 1001, but they may be simultaneously or sequentially performed by two or more processors 1001. The processor 1001 may be mounted as one or more chips.

The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like.

The memory 1002 can store a program (a program code), a software module, and the like that can be executed to perform a popularity estimation method according to an embodiment of the present invention.

The storage 1003 is a computer-readable storage medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media may be, for example, a database, a server, or another appropriate medium including at least one of the memory 1002 and the storage 1003.

The communication device 1004 is hardware (a transmitting and receiving device) that performs communication between computers via a wired network and/or a wireless network and is also referred to as, for example, a network device, a network controller, a network card, or a communication module.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The click rate prediction model construction device 1 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted as at least one piece of hardware.

While the embodiment has been described above in detail, it will be apparent to those skilled in the art that the embodiment is not limited to the embodiments described in this specification. The embodiment can be altered and modified in various forms without departing from the gist and scope of the present invention defined by description in the appended claims. Accordingly, the description in this specification is for exemplary explanation and does not have any restrictive meaning for the embodiment.

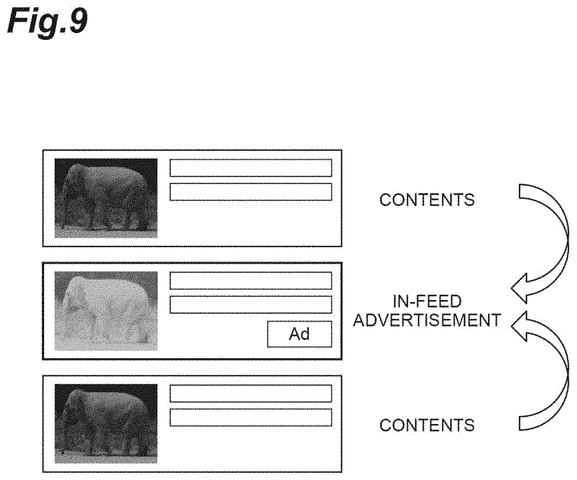

For example, the click rate prediction model construction device 1 may additionally learn a degree of association between a displayed advertisement and contents near the advertisement as a feature value and construct a click rate prediction model. That is, the click rate prediction model construction device 1 may learn a degree of association between an advertisement and contents as a feature value, for example, when the advertisement is an in-feed advertisement displayed between the contents as illustrated in FIG. 9. In this case, the acquisition unit 11 acquires a degree of association between a displayed advertisement and contents near the advertisement. The acquisition unit 11 acquires a degree of similarity between an image associated with a displayed advertisement and an image associated with contents near the advertisement or a degree of similarity between a genre of a displayed advertisement and a genre of contents near the advertisement as the degree of association between the displayed advertisement and the contents near the advertisement. The degree of association may be derived, for example, on the basis of a degree of similarity in details between an advertisement and contents, an interaction between a genre of an advertisement and a genre of contents, an arrangement of an advertisement relative to contents, a shape of an advertisement and contents, or the like. The model constructing unit 15 learns the degree of association (for example, a degree of similarity between images or an interaction term in genre) as a feature value and constructs a click rate prediction model.

A click rate is considered to change according to a degree of association between an advertisement and nearby contents thereof in addition to the advertisement. Accordingly, by learning a degree of association between an advertisement and contents near the advertisement as a feature value and constructing a click rate prediction model, it is possible to more accurately predict a click rate in consideration of an influence of nearby contents. A degree of similarity in image or a degree of similarity in genre is considered to be information appropriately indicating a degree of association between an advertisement and nearby contents. Accordingly, by learning feature values with a degree of similarity in image or a degree of similarity in genre as a degree of association and constructing a click rate prediction model, it is possible to predict a click rate with high accuracy in more appropriate consideration of an influence of nearby contents.

The aspects/embodiments described in this specification may be applied to a system using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), or other appropriate system and/or a next-generation system which is extended based thereon.

The order of the processing steps, the sequences, the flowcharts, and the like of the aspects/embodiments described above in this specification may be changed unless conflictions arise. For example, in the methods described in this specification, various steps are described as elements of the exemplary order, but the methods are not limited to the described order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in this specification may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

Regardless of whether it is called software, firmware, middleware, microcode, hardware description language, or another name, software can be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, wired technology and/or wireless technology is included in the definition of the transmission medium.

Information, signals, and the like described in this specification may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

Terms described in this specification and/or terms required for understanding this specification may be substituted with terms having the same or similar meanings.

Information, parameters, and the like described above in this specification may be expressed as absolute values, may be expressed as values relative to predetermined values, or may be expressed using other corresponding information.

A user terminal may also be referred to as a mobile communication terminal, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

The term “determining” or “determination” used in this specification may include various types of operations. The term “determining” or “determination” may include cases in which calculating, computing, processing, deriving, investigating, looking up (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.”

The expression “based on” used in this specification does not mean “based on only” unless otherwise described. In other words, the expression “based on” means both “based on only” and “based on at least.”

No reference to elements named with “first,” “second,” or the like used in this specification generally limit amounts or order of the elements. These naming can be used in this specification as a convenient method for distinguishing two or more elements.

Accordingly, reference to first and second elements does not mean that only two elements are employed or that a first element precedes a second element in any form.

When the terms “include” and “including” and modifications thereof are used in this specification or the appended claims, the terms are intended to have a comprehensive meaning similar to the term “comprising.” The term “or” used in this specification or the claims is not intended to mean an exclusive logical sum.

In this specification, two or more of any devices may be included unless the context or technical constraints dictate that only one device is included.

In the entire present disclosure, singular terms include plural referents unless the context or technical constraints dictate that a unit is singular.

### REFERENCE SIGNS LIST

1 . . . Click rate prediction model construction device
11 . . . Acquisition unit
13 . . . Image generating unit
14 . . . Derivation unit
15 . . . Model constructing unit

1: A click rate prediction model construction device comprising:
an image generating unit configured to generate a plurality of images similar to a basic image which is displayed as an advertisement;
a derivation unit configured to derive an estimated value of a click rate of each of the plurality of images on the basis of an actual value and a certainty factor of a click rate of the basic image; and
a model constructing unit configured to learn the actual value and the estimated value of the click rate of the basic image for each of the plurality of images and to construct a click rate prediction model,
wherein the derivation unit derives a value obtained by adding a noise corresponding to the certainty factor of the click rate of the basic image to the actual value of the click rate of the basic image as the estimated value of each of the plurality of images.

2: The click rate prediction model construction device according to claim 1, wherein the derivation unit increases the noise as the certainty factor of the click rate of the basic image decreases and decreases the noise as the certainty factor of the click rate of the basic image increases.

3: The click rate prediction model construction device according to claim 1, wherein the derivation unit adds the noise on the basis of a beta distribution with the actual value of the click rate of the basic image as a parameter.

4: The click rate prediction model construction device according to claim 1, further comprising an acquisition unit configured to acquire a degree of association between a displayed advertisement and contents near the advertisement,
wherein the model constructing unit additionally learns the degree of association as a feature value and constructs the click rate prediction model.

5: The click rate prediction model construction device according to claim 4, wherein the acquisition unit acquires a degree of similarity between an image associated with the displayed advertisement and an image associated with the nearby contents or a degree of similarity between a genre of the displayed advertisement and a genre of the nearby contents as the degree of association between the displayed advertisement and the nearby contents.
